(19) United States
(12) Patent Application Publication
(10) Pub. No.: US 2021/0264301 A1
(43) Pub. Date: Aug. 26, 2021

(54) Critical Event Intelligence Platform

(71) Applicant: OnSolve, LLC, Ormond Beach, FL (US)

(72) Inventors: Shane Walker, Kent, WA (US); David Ulrich, Seattle, WA (US); Jason Flaks, Redmond, WA (US); Julia Bauer, Austin, TX (US); Hollis Christopher Hurst, III, Santa Monica, CA (US); Greg Adams, Seattle, WA (US)

(21) Appl. No.: 17/180,186

(22) Filed: Feb. 19, 2021

Related U.S. Application Data
(60) Provisional application No. 62/979,751, filed on Feb. 21, 2020.

(51) Int. Cl. G06N 5/04; G06N 20/00; G06F 16/33; G06F 16/63; G06F 16/73

(52) U.S. Cl. CPC G06N 5/04; G06N 20/00; G06F 16/73; G06F 16/63; G06F 16/33

(57) ABSTRACT

The present disclosure provides computing systems and methods for critical event detection and response, including event monitoring, asset intelligence, and/or mass notifications. As examples, the critical event intelligence platform described herein can be used for security, travel, logistics, finance, intelligence, and/or insurance teams responsible for business continuity, physical safety, duty of care, and/or other operational tasks. The proposed critical event intelligence platform provides users with the speed, coverage and actionability needed to respond effectively in a fast-paced and dynamic critical event environment.

### RELATED APPLICATIONS

This application claims priority to and the benefit of U.S. Provisional Patent Application No. 62/979,751, filed Feb. 21, 2020, which is hereby incorporated by reference in its entirety.

### FIELD

The present disclosure relates generally to computing systems and platforms for detecting and responding to critical events. More particularly, the present disclosure relates to computing systems and methods for critical event detection and response, including event monitoring, asset intelligence, and/or mass notifications.

### BACKGROUND

Critical events disrupt lives and hurt the economy. In particular, natural and man-made disasters impact more than 150 million people annually, while thousands of potential critical events happen every day.

As more companies or other organizations have people, operations, or other assets around the globe, they face complex challenges in responding to these critical events. In particular, many organizations (e.g., companies) have international vendors and operations, globally distributed facilities, on-demand supply chains, and mobile workforces.

The increasing frequency and intensity of critical events—combined with the proliferation of news sources and the expansion of locations to monitor—has made it infeasible for organizations' operations teams to meaningfully manually digest and act upon intelligence information to ensure the safety and optimization of the organizations' assets (e.g., human personnel).

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for critical event intelligence. The method includes obtaining, by a computing system comprising one or more computing devices, a set of intelligence data that describes conditions at one or more geographic areas. The method includes detecting, by the computing system, one or more events based at least in part on the set of intelligence data. The method includes determining, by the computing system, a location for each of the one or more events. The method includes identifying, by the computing system, one or more assets associated with an organization. The method includes determining, by the computing system, whether one or more event response activities are triggered based at least in part on the location for each of the one or more events and the one or more assets associated with the organization. The method includes, responsive to a determination that the one or more event response activities are triggered, performing, by the computing system, the one or more event response activities.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system for critical event intelligence according to example embodiments of the present disclosure.

FIG. 2 depicts a block diagram of an example computing system for using and enabling machine-learned models according to example embodiments of the present disclosure.

FIG. 3 depicts a flowchart diagram for an example method for detecting and responding to critical events according to example embodiments of the present disclosure.

FIG. 4 depicts a block diagram of an example workflow to train a machine-learned model according to example embodiments of the present disclosure.

FIG. 5 depicts a block diagram of an example workflow to generate inferences with a machine-learned model according to example embodiments of the present disclosure.

FIGS. 6A-F depict example dashboard user interfaces according to example embodiments of the present disclosure.

FIGS. 7A-B depict example event reports according to example embodiments of the present disclosure.

FIGS. 8A-B depict example mobile application user interfaces according to example embodiments of the present disclosure.

### DETAILED DESCRIPTION

### Overview

Generally, aspects of the present disclosure are directed to computing systems and methods for critical event detection and response, including event monitoring, asset intelligence, and/or mass notifications. Example events can include emergency events that were not previous scheduled (e.g., acts of violence) or can include previous scheduled events such as concerts, sporting events, and/or other scheduled events (e.g., that can be updated and/or disrupted). The critical event intelligence platform described herein can be used for security, travel, logistics, finance, intelligence, and/or insurance teams responsible for business continuity, physical safety, duty of care, and/or other operational tasks. The proposed critical event intelligence platform provides users with the speed, coverage and actionability needed to respond effectively in a fast-paced and dynamic critical event environment.

Specifically, through the use of machine learning and other forms of artificial intelligence, the critical event intelligence platform can immediately understand what kind of event(s) are happening globally, where the event(s) are happening, and the potential causality for how the event(s) impact various organizational operations or assets or even other events such as predicted events. This real-time insight can be used to power informative and/or automated alerts, notifications, revised operational protocols, and/or other event response activities, enabling organizations to take decisive action to keep their assets safe and their operations on track. Thus, the proposed systems and methods make it possible for an organization to track events across every time zone, sort through the noise, and correlate events to the locations of the organization's employees, suppliers, facilities, and supply chain nodes when minutes make all the difference. As such, aspects of the present disclosure can serve to “normalize” data from many different and disparate sources to provide discrete and actionable insight(s).

With reference now to the Figures, example embodiments of the present disclosure will be discussed in further detail.

### Example Devices and Systems

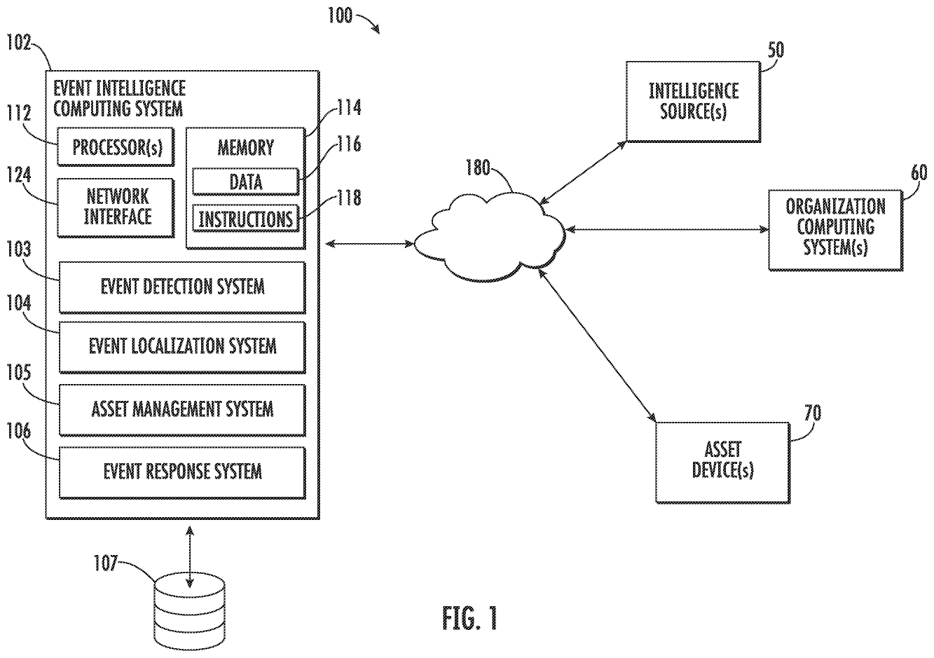

FIG. 1 depicts a block diagram of an example system 100 for detection and/or response to critical events. The system 100 includes an event intelligence computing system 102, one or more intelligence sources 50, one or more organization computing systems 60, and one or more asset devices 70 that are communicatively connected over one or more networks 180.

In general, the event intelligence computing system 102 can perform critical event detection and response. Specifically, in some implementations, the event intelligence computing system 102 can include an event detection system 103, an event localization system 104, an asset management system 105, and an event response system 106. The operation of each of these systems is described in further detail below.

The event intelligence computing system 102 can receive intelligence data from the intelligence sources 50. The intelligence data provided by the intelligence sources 50 can describe conditions at one or more geographic areas. For example, the intelligence data can be real-time or near-real-time data that describes current or near-current conditions at the one or more geographic areas. Intelligence data can also include historical data related to past occurrences and/or future or projected data related to future events that are predicted or scheduled. The geographic areas can be specific geographic areas of interest or can be unconstrained areas (e.g., cover the entire Earth).

In some instances, the intelligence data from the intelligence sources 50 can be structured data. For example, the structured data can be provided by one or more structured data feeds such as data feeds produced by one or more governmental agencies. As an example, a structured data feed might include structured data describing the past, current, and/or predicted future weather conditions (e.g., including weather alerts or advisories) at various locations which may, for example, be provided by a governmental agency such as the National Oceanic and Atmospheric Administration or a private firm such as a private weather monitoring service. Another example is a data feed of structured seismographic data or alerts provided by, for example, the International Federation of Digital Seismograph Networks, National Earthquake Information Center, Advanced National Seismic System, etc. Yet another example is the Geospatial Multi-Agency Coordination feed of wildfire data provided by the United States Geological Survey. Many other structured feeds of intelligence data are possible.

In other instances, the intelligence data from the intelligence sources 50 can be unstructured data. Unstructured data can include natural language data, image data, and/or other forms of data. For example, unstructured intelligence data can include social media posts obtained from one or more social media platforms and/or one or more news articles. For example, a social media post may include an image or text that describes a current or recently occurred event (e.g., a microblogging account associated with a city fire department may provide updates regarding ongoing fire events within the city). Likewise, a news article or similar item of content may describe a current or recently occurred event (e.g., a news alert may describe an ongoing police chase within a particular neighborhood). Thus, the intelligence sources 50 can, in some instances, be webpages or other web documents that include unstructured information, and which are accessible (e.g., via the World Wide Web and/or one or more application programming interfaces) by the event intelligence computing system 102. In another example, the intelligence sources 50 can include radio systems such as radio broadcasts. For example, speech to text technologies can be used to generate text readouts of radio broadcasts which can be used as intelligence data.

In another example, the unstructured intelligence data can include image data such as street-level data, photographs, aerial imagery, and/or satellite imagery. As an example, satellite imagery can be obtained from various governmental agencies (e.g., the NOAA National Environmental Satellite, Data, and Information Service (NESDIS), NASA's Land, Atmosphere Near real-time Capability for EOS (LANCE), etc.) or from private firms. Intelligence data can also include other geographic data from a geographic information system such as real-time information about traffic incidents/collisions, police activity, wildfire data, etc.

Intelligence data can also include real-time and/or delayed and/or previously-recorded video and/or audio from various sources such as various cameras (e.g., security cameras such as “doorbell cameras”, municipal camera systems, etc.), audio sensors (e.g., gunshot detection systems), radio broadcasts, television broadcasts, Internet broadcasts or streams, and/or environmental sensors (e.g., wind sensors, rain sensors, motion sensors, door sensors, etc.). Intelligence sources 50 can further include various Internet of Things devices, edge devices, embedded devices, and/or the like which capture and communicate various forms of data. Additional feeds include data from public facilities (e.g., transportation terminals), event venues, and energy facilities and pipelines. In some examples, audio data can be converted into textual data (e.g., via speech-to-text systems, speech recognition systems, or the like) by the event intelligence computing system 102.

Thus, the intelligence sources 50 can provide various forms of intelligence data that describe conditions that are occurring or that have recently occurred (e.g., within some recent time period such as the last 24 hours, last 6 hours, etc.) within various geographic areas. Specifically, example implementations of the event intelligence computing system 102 can mine a significant number of data sources (e.g., more than 15,000) to provide comprehensive geographical coverage. The event intelligence computing system 102 can ingest both structured and unstructured data from trusted sources including government bureaus, weather and geological services, local and international press, and social media. The event intelligence computing system 102 can integrate these and other sources to provide the most robust global coverage possible. Specifically, a mix of hyper-local, regional, national and international sources shed light on global incidents as well as local incidents with global impacts.

In another example, the intelligence sources 50 can include crowdsources of crowdsourcing information. For example, live information can be reported by various members of a crowdsourcing structure. The live information can include textual, numerical, or pictorial updates regarding the status of events, locations, or other conditions around the world.

The organization computing systems 60 can be computing systems that are operated by or otherwise associated with one or more organizations and/or administrators or representatives thereof. As examples, organizations can include companies, governmental agencies, academic organizations or schools, military organizations, individual users or groups of users, unions, clubs, and/or the like. In one example, an organization may operate an organization computing system 60 to: receive, monitor, search, and/or upload critical event information to/from the event intelligence computing system 102; communicate with asset devices 70; modify settings or controls for receipt or processing of critical event information related to the particular organization; and/or the like.

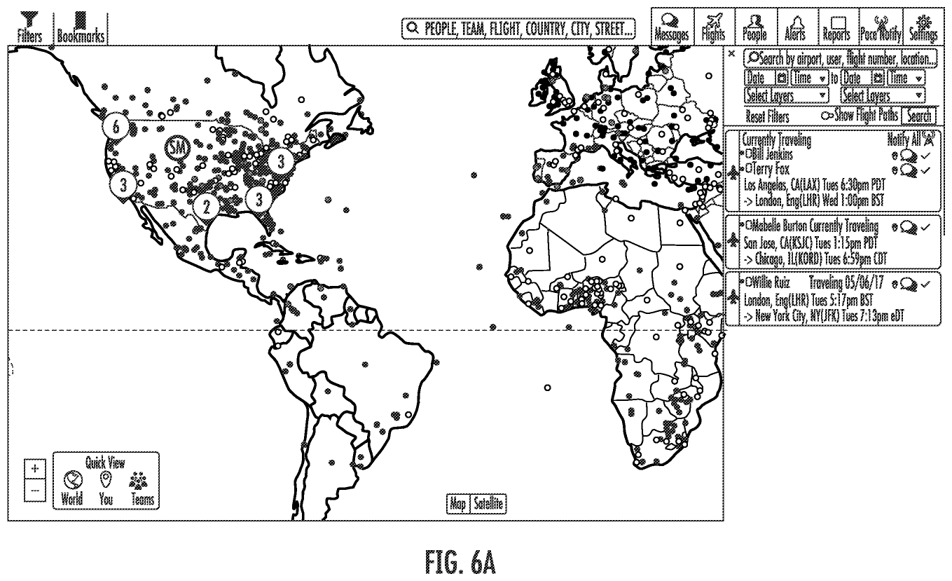

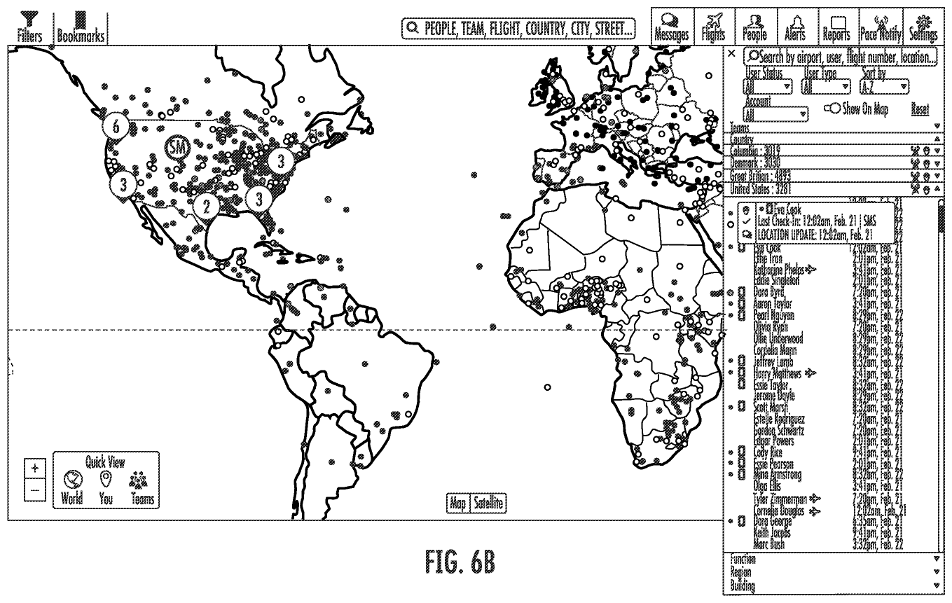

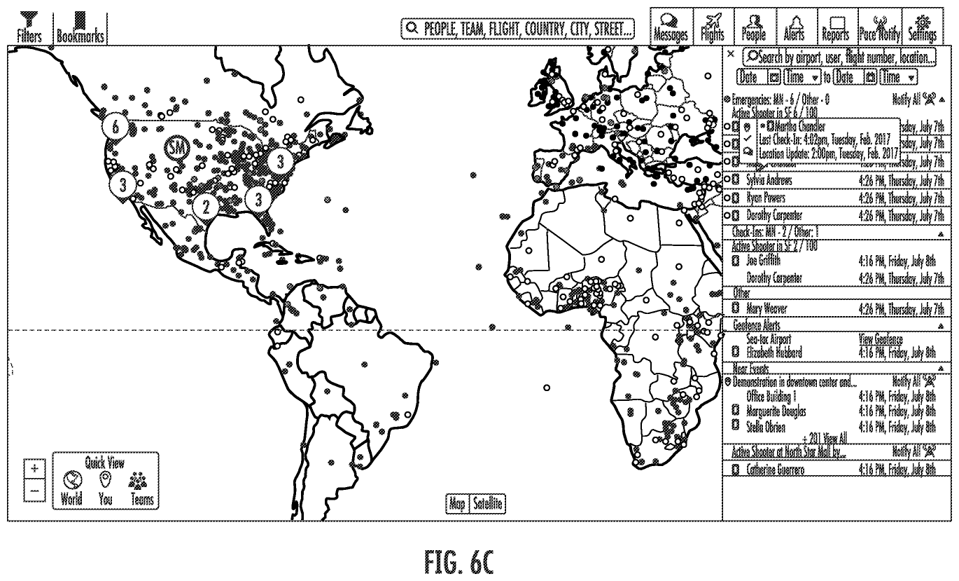

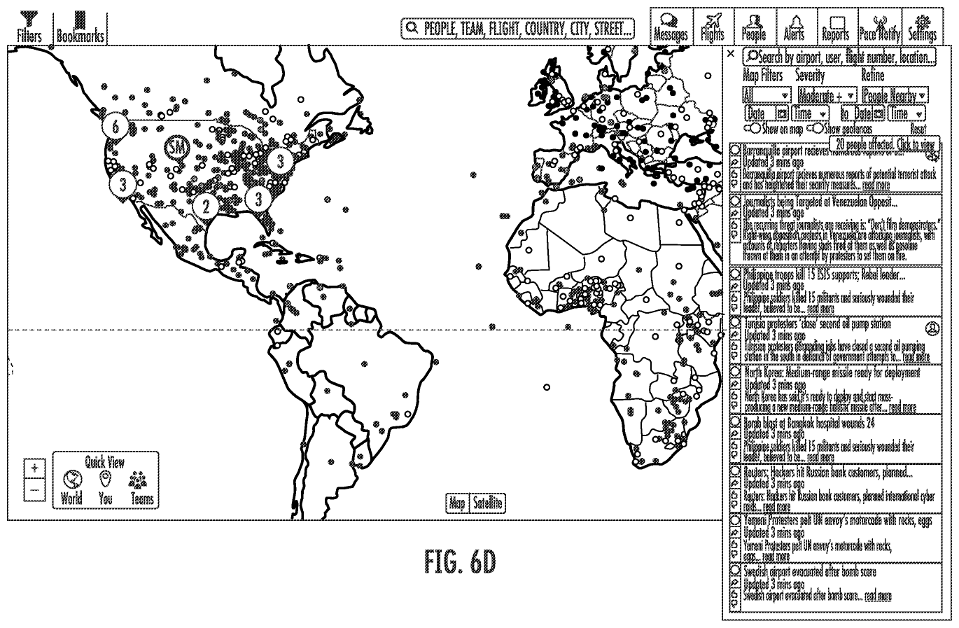

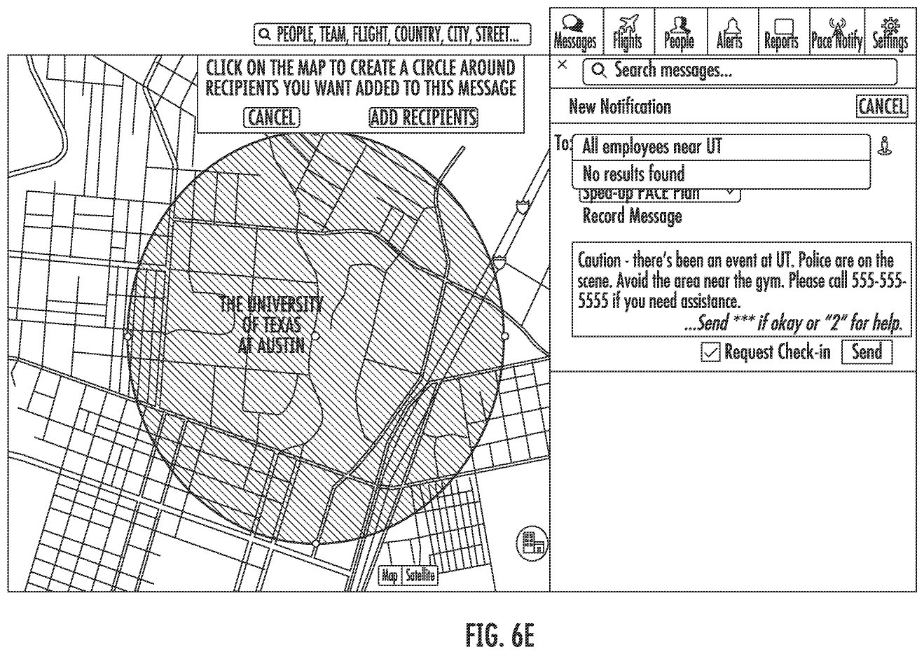

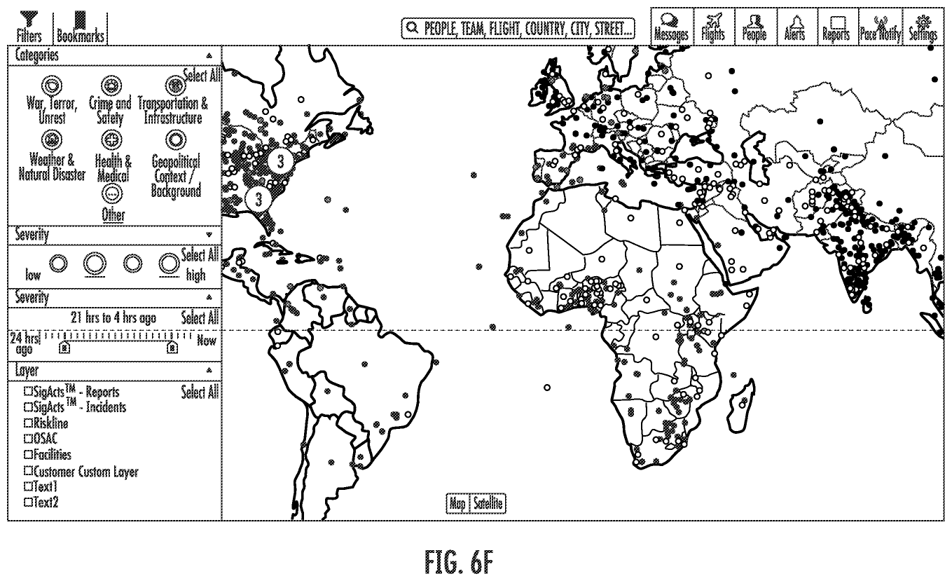

Thus, one or more organizations may choose to subscribe to or otherwise participate in the critical event system and may use respective organization computing systems 60 to interact with the system to receive critical event information. As one example, a representative of an organization (e.g., an administrator included in the organization's operations team) can use an organization computing system 60 to communicate with the event intelligence computing system 102 to receive and interact with a critical event dashboard user interface, for example, such as is shown in FIGS. 6A-F. For example, the dashboard interface can be served by system 102 to organization computing system 60 as part of a web application accessed via a browser application. In another example, the underlying data for the dashboard interface can be served by event intelligence computing system 102 to a dedicated application executed at the organization computing system 60. The dashboard can include robust filtering options such as filters for referenced entities, locations, and/or risk type, time, and/or severity. The event intelligence computing system 102 can store the underlying data (e.g., event data, etc.) in a database 107. An organization computing system 60 can include any number of computing devices such as laptops, desktops, personal devices (e.g., smartphones), server devices, etc.

The asset devices 70 can be associated with one or more assets. In particular, one or more assets may be associated with an organization. An asset can include any person, object, building, device, commodity, and/or the like for which an organization is interested in receiving critical event information. As one example, assets can include human personnel that are employees of or otherwise associated with an organization. As another example, assets can include vehicles (e.g., delivery or service vehicles) that are used by an organization to perform its operations. Vehicles may or may not be capable of autonomous motion. As yet another example, assets can include objects (e.g., products or cargo) that are being transported as part of the organization's operations (e.g., supply chain operations). As yet another example, assets can include physical buildings in which the organization or its other assets work, reside, operate, etc. Assets can also include the contents of an organization's buildings such as computing systems (e.g., servers), physical files, and the like. As another example, assets can include virtual assets such as data files, digital assets, and/or the like. As another example, assets can include named entities of interest that may appear in the news, such as a company name, brands, or other intangible corporate assets.

In some implementations, one or more asset devices 70 can be associated with each asset. As one example, a human personnel may carry an asset computing device (e.g., smartphone, laptop, personal digital assistant, etc.). As another example, a vehicle or other movable object may have an asset device 70 attached thereto (e.g., navigation system, vehicle infotainment system, GPS tracking system, autonomous motion control systems, etc.). As further examples, buildings can have any number of asset devices 70 contained therein (e.g., electronic locks, security systems, camera systems, HVAC systems, lighting systems, plumbing systems, other computing devices, etc.).

In some implementations, assets can be under the control of the organization with which they are associated. For example, a set of office buildings that are managed or leased by an organization may be considered assets of the organization. In other implementations, assets can be associated with an organization (e.g., of interest to the organization), but not necessarily under the control of the organization. For example, a trucking delivery company may use various trucking depots to facilitate their operations, but may not necessarily have any ownership in or control over the trucking depots. Regardless, the trucking delivery company may indicate, within the event intelligence computing system 102, that the trucking depots are assets associated with the company so that the trucking company can receive updates, alerts, etc. that relate to critical events occurring at the trucking depots (e.g., which may impact the operations of the trucking company). In another example, a certain product manufacturer may rely upon a certain supplier to supply a portion of their product. The product manufacturer may associate the supplier's facilities as assets of interest to the product manufacturer so that the product manufacturer receives updates, alerts, or automated activities if a critical event occurs at the supplier's facilities, thereby enabling the manufacturer to efficiently react to a potential disruption in the supplier's capabilities.

Thus, assets may be associated with an organization (e.g., based on input received from the organization) whether or not they are under the specific control of the organization. In some implementations, an organization can associate various assets with the organization via interaction with the event intelligence computing system 102 and these associations can be stored in a database 107 that stores various forms of data for the system 102.

Thus, asset devices 70 include various different types and forms of devices that are able to communicate over the network(s) 180 with the event intelligence computing system 102. For example, the asset devices 70 can provide information about the current state of the asset (e.g., location data such as GPS data); receive and display alerts to an asset; enable an asset to communicate (e.g., with the organization computing system 60); and/or be remotely controlled by the event intelligence computing system 102 and/or an associated organization computing system 60. Certain types of asset devices 70 may have a display screen and/or input components such as a microphone, camera, and/or physical or virtual keyboard.

In general, the event intelligence computing system 102 can receive and synthesize information from each of the intelligence sources 50, the organization computing systems 60, and/or asset devices 70 to produce reports, data tables, status updates, alerts, and/or the like that provide information regarding critical events. In some implementations, communications between the system 102 and one or more of the intelligence sources 50, the organization computing systems 60, and/or asset devices 70 can occur via or according to one or more application programming interfaces (APIs) to facilitate automated and/or simplified data acquisition and/or transmission. In some implementations, the API(s) can be integrated directly into applications (e.g., applications executed by the organization computing devices 60) to improve predictive analytics, manage supply chain nodes, and evaluate mitigation plans for assets.

The event intelligence computing system 102 can include any number of computing devices such as laptops, desktops, personal devices (e.g., smartphones), server devices, etc. Multiple devices (e.g., server devices) can operate in series and/or in parallel.

The event intelligence computing system 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, one or more memory devices, flash memory devices, etc., and combinations thereof.

The memory 114 can store information that can be accessed by the one or more processors 112. For instance, the memory 114 (e.g., one or more non-transitory computer-readable storage mediums, memory devices) can store data 116 that can be obtained, received, accessed, written, manipulated, created, and/or stored. In some implementations, the event intelligence computing system 102 can obtain data from one or more memory device(s) that are remote from the system 102.

The memory 114 can also store computer-readable instructions 118 that can be executed by the one or more processors 112. The instructions 118 can be software written in any suitable programming language or can be implemented in hardware. Additionally, or alternatively, the instructions 118 can be executed in logically and/or virtually separate threads on processor(s) 112. For example, the memory 114 can store instructions 118 that when executed by the one or more processors 112 cause the one or more processors 112 to perform any of the operations and/or functions described herein, including implementing the event detection system 103, the event localization system 104, the asset management system 105, and the event response system 106.

The event detection system 103 can detect one or more events based at least in part on the intelligence data collected from the intelligence sources 50. In some implementations, the event detection system 103 can first clean or otherwise pre-process the intelligence data. Pre-processing the intelligence data can include removing or modifying context-specific formatting such as HTML, formatting or the like to place the intelligence data into a common format. As other examples, pre-processing the intelligence data can include performing speech to text, computer vision, and/or other processing techniques to extract semantic features from raw intelligence data.

In some implementations, the event detection system 103 can include and use one or more machine-learned models to assist in detecting the one or more events based at least in part on the intelligence data. As one example, pre-processing the intelligence data can include initially filtering the intelligence data for usefulness. In particular, in some implementations, the event detection system can include a machine-learned usefulness model to screen intelligence data based on usefulness. For example, the machine-learned usefulness model can be a binary classifier that indicates whether a given item of intelligence is useful or not. Items of intelligence that are classified as non-useful can be discarded. This pre-filtering step can reduce the amount of data that the system is required to process, leading to faster results that are more accurate and relevant to critical events.

As another example, the event detection system 103 can include a machine-learned event classification model that is configured to classify intelligence data as corresponding to one or more classes of events. Thus, in some implementations, the event detection system can input at least a portion of the set of intelligence data into the machine-learned event classification model and can process the portion of the set of intelligence data with the machine-learned event classification model to produce one or more event inferences as an output of the machine-learned event classification model. Each of the one or more event inferences detects one of the events and classifies the event into an event type.

Thus, machine learning algorithms can search for and identify risk-related incidents spanning any number of different event types. In some implementations, the event detection system 103 can classify critical events into three major categories based on whether they are naturally occurring, accidental (unintentional, negligence, etc.), or intentionally caused by humans. Specifically, a natural event (e.g., flood, earthquake, etc.) can be an event that has financial, operational, or safety/security implications for an organization's assets (e.g., people, property/buildings, product, supply chain, infrastructure, etc.). An accidental event can be a malfunction or human error in controlling a technology system (e.g., buildings, dams, vehicles, etc.) that has financial, operational, or safety/security implications for an organization's assets (e.g., people, property/buildings, product, supply chain, infrastructure, etc.). A human event can be an intentional human action (crime, military or paramilitary action, etc.) that has financial, operational, or safety/security implications for an organization's assets (e.g., people, property/buildings, product, supply chain, infrastructure, etc.).

In some implementations, this ontology can be further refined into sub-classes that provide distinct labeling by incident type. Take for instance, fire. A fire event can range from a controlled burn, a forest fire burning out of control, a chemical explosion, or arson. The difference matters in mounting an effective response. A robust event taxonomy allows the event intelligence system 102 to start with the highest order of data (e.g., initial satellite footage of smoke, which pinpoints a geo-location), then quickly parse and overlay additional information from other to characterize the fire type and cause.

The event localization system 104 can determine a location and/or time for each of the one or more events detected by the event detection system 103. In some implementations, the localization process can be referred to as “geoparsing” or “geographic disambiguation.”

In particular, the event localization system 104 can evaluate the data associated with an event to identify the people, places, and things (referred to collectively as “location type entities”) that are mentioned in the intelligence data and organize them into a single event report. Identification of the people, places, and things mentioned in the data can be performed via a combination of named entity recognition and a gazetteer (e.g., which may serve as a vocabulary for the named entity recognition). Thus, the event localization system 104 can perform event intelligence aggregation (e.g., all of the articles and metadata for one event goes together).

After analyzing and aggregating all the data inputs from many different sources together, the event localization system 104 can run voting algorithms to narrow the specifics about the location. For example, the voting can rely upon a scheme which understands (e.g., through application of the gazetteer) when certain entities are “contained” within or otherwise subsumed by other entities (e.g., the entity of ‘Seattle’ is contained within the entity of ‘Washington State’).

In addition, the voting scheme employed by the event localization system 104 can rely upon dependency parsing. Specifically, the event localization system 104 can read the provided text content and build a map of the grammatical structure of the document(s). For example, the event localization system 104 can mark and label all the different types of grammar in a document associated with an event. This allows the event localization system 104 to look for a particular verb, event, etc. or to see if there is a location that is of interest and know that there is a dependency between those things. Through the application of the voting algorithms, the event localization system 104 can remove location data that is not relevant to the event itself.

Thus, in some implementations, the event localization system 104 can determine the location for each event by detecting one or more location type entities within a portion of the set of intelligence data associated with the event. The event localization system 104 can select a first location type entity for the event based on the one or more location type entities, a gazetteer, and the portion of the set of intelligence data associated with the event.

In some implementations, the event localization system 104 can include and use one or more machine-learned models to assist in determining the location for each event. For example, the event localization system 104 can include a machine-learned event localization model configured to determine the location and/or time of an event based on intelligence data related to the event. Thus, in some implementations, the event localization system 104 can input at least a portion of the set of intelligence data associated with the event into the machine-learned event localization model and can process the portion of the set of intelligence data with the machine-learned event localization model to produce an event location inference as an output of the machine-learned event localization model. The event location inference can identify the location and/or time for the event.

In some implementations, the event localization system 104 can also determine a severity level for each of the one or more events. The severity level for each event can be based on the underlying intelligence data, the event type of the event, and/or user input (e.g., user-specified levels can be assigned to different event types). The severity level can generally indicate a magnitude of risk of damage to assets of the organization. In some implementations, the severity level can also be based on and/or indicative of whether the event has concluded or is ongoing. As will be described further below, the severity level of an event can be used to determine whether to take certain event response actions and, if so, which actions should be taken.

In some implementations, severity level can be determined and/or expressed based on information contained in the following three vectors: Amount: how much damage occurred? Was there a lot or a little damage? Place and time: is the event done or ongoing? Is it something that's happening in the future? Point location: what's the geographical impact? For example, this can sometimes be defined or represented by a geometry, and locations or geometries may be dynamic over time.

In some implementations, the event localization system 104 can include and use one or more machine-learned models to assist in determining a severity level for each of the one or more events based at least in part on the intelligence data. For example, the event localization system 104 can include a machine-learned event severity model that is configured to infer a severity level for each event. Thus, in some implementations, the event detection system can input at least a portion of the set of intelligence data and/or the event type classification into the machine-learned event severity model and can process the input data with the machine-learned event severity model to produce one or more event severity inferences as an output of the machine-learned event severity model. Each of the one or more event severity inferences predicts a severity level of a corresponding event.

In some implementations, the event localization system 104 can cluster the events to determine one or more event clusters. For example, the events can be clustered based at least in part on time and/or based at least in part on location (e.g., as previously determined by the event localization system 104). Clustering of the events can reduce redundant event alerts or other event response actions.

The asset management system 105 can manage one or more assets associated with an organization. For example, for a given organization, the asset management system 105 can identify (e.g., by accessing database 107) a set of assets that are associated with such organization. The asset management system 105 can, for example, determine a respective asset location for each of the assets. For example, the asset location data can be generated or determined from location updates received from the asset devices 70 (e.g., which may itself be generated from global positioning system data).

The event response system 106 can determine whether one or more event response activities are triggered based at least in part on the location determined for each of the one or more events by the event localization system 104 and/or based at least in part on the asset data produced by the asset management system. For example, for each event and for each organization, the event response system 106 can evaluate a set of rules (e.g., which may be organization-specific) to determine whether the event triggers any event response activities. For example, the rules may evaluate event type, event severity, event location, asset data (e.g., asset ID, current locations, etc.), the underlying intelligence data, and/or other relevant data to determine whether a response has been triggered and, if so, which response has been triggered. In some instances, the rules can be logical conditions that must be met for an event to be triggered.

In some implementations, users (e.g., organizations) can be provided with a user interface that enables the organization to modify, define, or otherwise control the set of rules that are applied to determine whether an event response has been triggered. The user interface can allow the organization to select combinations of certain assets, locations, event types, etc. that result in particular event response activities. For example, a certain event type within a certain distance from a certain asset may trigger an alert to an asset device 70 associated with the asset and an alert to an administrator of the organization computing system 60.

As one example, for a given organization, the event response system 106 can determine whether one or more event response activities are triggered based on the location(s) of the event(s) relative to the location(s) of some or all of the assets associated with the organization. For example, in some implementations, if any asset is located within a threshold distance from the location of an event, then an event response action can be triggered and performed. For example, the event response action can include sending an alert to one or more asset devices 70 associated with the asset(s) that are within the threshold distance from the event. In some implementations, the threshold distance can be different for each event type and/or asset. In some implementations, the threshold distance can be dynamic over time. In some implementations, the threshold distance can be user specified. In some implementations, the threshold distance can be machine-learned.

As another example, contextual information about an asset (e.g., which may be inferred from email data, calendar data, current navigational data, etc.) and/or the event can be used to determine whether an event response activity has been triggered (e.g., regardless of whether the asset is specifically and currently within a threshold distance from the event). As one example, a human personnel asset may have a flight itinerary booked from New York to Istanbul that connects via London's Heathrow Airport. If the event intelligence system 102 detects an event (e.g., act of violence, major winter storm, etc.) at Heathrow Airport, an event response may be triggered (e.g., re-book the human personnel's flight via a different connecting airport), even though the human personnel is not currently in the London area. Thus, event response activities may be triggered if some nexus (e.g., potentially other than current co-location) between an asset and an event can be derived (e.g., based on contextual data).

As another example, in some implementations, the event response system 106 can include and use one or more machine-learned models to assist in determining an appropriate response to detected events. For example, the event response system 106 can include a machine-learned event response model that is configured to infer an event response activity (or lack thereof) for a pair of event and organization. Thus, in some implementations, the event detection system can input event type, event severity, event location, asset data, the underlying intelligence data, and/or other relevant data into the machine-learned event response model and can process input data with the machine-learned event response model to produce one or more event response inferences as an output of the machine-learned event response model. Each of the one or more event response inferences can indicate whether an event response activity should be performed and, if so, which event response activity should be performed.

If the event response system 106 determines that one or more event response activities are triggered, the event response system 106 can perform the one or more event response activities.

As one example, an event response activity can include transmitting an alert to one or more organization computing systems 60 and/or one or more asset devices 70. The alert can describe the event and can provide information about how to respond to the event (e.g., lock doors, avoid area, call number for instruction, etc.)

As another example, an event response activity can include taking automated actions to counteract the event. As examples, event response activities can include: automatically locking doors (e.g., by communicating with electronic locking systems which serve as asset devices 70); re-routing assets such as human personnel or vehicles (e.g., by generating and transmitting updated itineraries, transportation routings, providing alternative autonomous motion control instructions, or the like); automatically modifying supply chain operations (e.g., re-routing certain portions of the supply chain to alternative suppliers/distributors/customers, changing transportation providers or channels, recalling certain items, etc.); automatically managing virtual assets (e.g., transferring sensitive data from a storage device in a building that has or might be infiltrated, attacked, or otherwise subject to damage to an alternative storage device, performing an automated reallocation among different asset classes, etc.)

Thus, to reduce the risk profile for an organization, the event intelligence system 102 can connect an event with organization data on the current or future location of assets such as facilities, supply chain nodes, and traveling employees. This programmatic correlation allows response teams to move quickly to protect people and assets. The event intelligence system 102 filters critical event information into a clear operating picture so that organizations can achieve better financial, operations and safety results.

Each of the event detection system 103, the event localization system 104, the asset management system 105, and the event response system 106 can include computer logic utilized to provide desired functionality. Each of the event detection system 103, the event localization system 104, the asset management system 105, and the event response system 106 can be implemented in hardware, firmware, and/or software controlling a general purpose processor. For example, in some implementations, each of the event detection system 103, the event localization system 104, the asset management system 105, and the event response system 106 includes program files stored on a storage device, loaded into a memory and executed by one or more processors. In other implementations, each of the event detection system 103, the event localization system 104, the asset management system 105, and the event response system 106 includes one or more sets of computer-executable instructions that are stored in a tangible computer-readable storage medium such as RAM hard disk or optical or magnetic media.

The database 107 can be one database or multiple databases. If multiple databases are used, they can be co-located or geographically distributed. The database 107 can store any and all of the different forms of data described herein and can be accessed and/or written to by any of the systems 103-106. In some implementations, the database 107 can also store historical data that can be used, for example, as training data for any of the machine-learned models described herein and/or as the basis for inferring certain information for current event or intelligence data. For example, the historical data can be collected and stored (e.g., in the database 107) over time.

The event intelligence computing system 102 can also include a network interface 124 used to communicate with one or more systems or devices, including systems or devices that are remotely located from the event intelligence computing system 102. The network interface 124 can include any circuits, components, software, etc. for communicating with one or more networks (e.g., 180). In some implementations, the network interface 124 can include, for example, one or more of a communications controller, receiver, transceiver, transmitter, port, conductors, software and/or hardware for communicating data. Similarly, the machine learning computing system 130 can include a network interface 164.

The network(s) 180 can be any type of network or combination of networks that allows for communication between devices. In some embodiments, the network(s) can include one or more of a local area network, wide area network, the Internet, secure network, cellular network, mesh network, peer-to-peer communication link and/or some combination thereof and can include any number of wired or wireless links. Communication over the network(s) 180 can be accomplished, for instance, via a network interface using any type of protocol, protection scheme, encoding, format, packaging, etc.

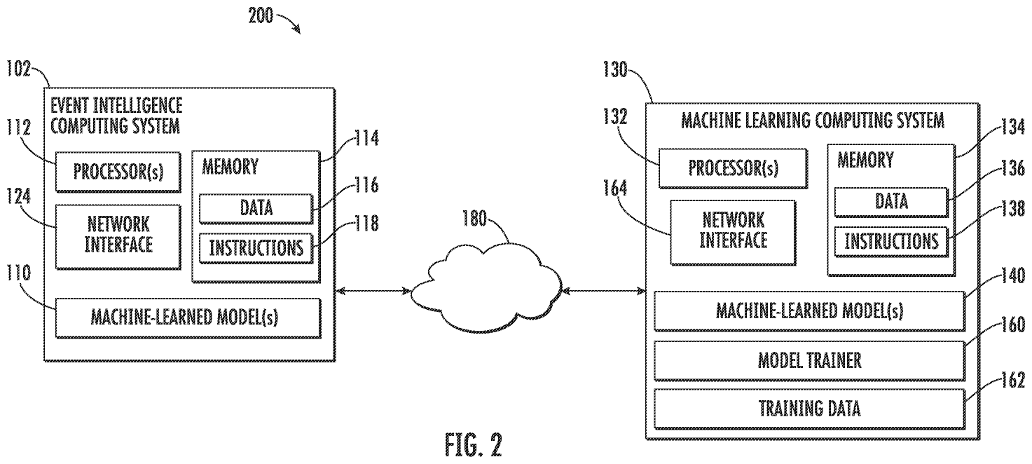

In some implementations, some or all of the event detection system 103, the event localization system 104, the asset management system 105, and the event response system 106 can include one or more machine-learned models. FIG. 2 depicts an example computing system 200 for enabling the event detection system 103, the event localization system 104, the asset management system 105, and/or the event response system 106 to include machine learning components according to example embodiments of the present disclosure. The example system 200 can be included in or implemented in conjunction with the example system 100 of FIG. 1. The system 200 includes the event intelligence computing system 102 and a machine learning computing system 130 that are communicatively coupled over the network 180.

As illustrated in FIG. 2, in some implementations, the event intelligence computing system 102 can store or include one or more machine-learned models 110 (e.g., any of the models discussed herein). For example, the models 110 can be or can otherwise include various machine-learned models such as a random forest model; a linear model, a logistic regression model; a support vector machine; one or more decision trees; a neural network; and/or other types of models including both linear models and non-linear models. Example neural networks include feed-forward neural networks, recurrent neural networks (e.g., long short-term memory recurrent neural networks), convolutional neural networks, or other forms of neural networks.

In some implementations, the event intelligence computing system 102 can receive the one or more machine-learned models 110 from the machine learning computing system 130 over network 180 and can store the one or more machine-learned models 110 in the memory 114. The event intelligence computing system 102 can then use or otherwise implement the one or more machine-learned models 110 (e.g., by processor(s) 112).

The machine learning computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage media, such as RAM, ROM, EEPROM, EPROM, one or more memory devices, flash memory devices, etc., and combinations thereof.

The memory 134 can store information that can be accessed by the one or more processors 132. For instance, the memory 134 (e.g., one or more non-transitory computer-readable storage mediums, memory devices) can store data 136 that can be obtained, received, accessed, written, manipulated, created, and/or stored. In some implementations, the machine learning computing system 130 can obtain data from one or more memory device(s) that are remote from the system 130.

The memory 134 can also store computer-readable instructions 138 that can be executed by the one or more processors 132. The instructions 138 can be software written in any suitable programming language or can be implemented in hardware. Additionally, or alternatively, the instructions 138 can be executed in logically and/or virtually separate threads on processor(s) 132.

For example, the memory 134 can store instructions 138 that when executed by the one or more processors 132 cause the one or more processors 132 to perform any of the operations and/or functions described herein.

In some implementations, the machine learning computing system 130 includes one or more server computing devices. If the machine learning computing system 130 includes multiple server computing devices, such server computing devices can operate according to various computing architectures, including, for example, sequential computing architectures, parallel computing architectures, or some combination thereof.

In addition or alternatively to the model(s) 110 at the event intelligence computing system 102, the machine learning computing system 130 can include one or more machine-learned models 140. For example, the models 140 can be or can otherwise include various machine-learned models such as a random forest model; a logistic regression model; a support vector machine; one or more decision trees; a neural network; and/or other types of models including both linear models and non-linear models. Example neural networks include feed-forward neural networks, recurrent neural networks (e.g., long short-term memory recurrent neural networks), convolutional neural networks, or other forms of neural networks.

As an example, the machine learning computing system 130 can communicate with the event intelligence computing system 102 according to a client-server relationship. For example, the machine learning computing system 140 can implement the machine-learned models 140 to provide a web service to the event intelligence computing system 102. For example, the web service can provide an event intelligence service and/or other machine learning services as described herein.

Thus, machine-learned models 110 can be located and used at the event intelligence computing system 102 and/or machine-learned models 140 can be located and used at the machine learning computing system 130.

In some implementations, the machine learning computing system 130 and/or the event intelligence computing system 102 can train the machine-learned models 110 and/or 140 through use of a model trainer 160. The model trainer 160 can train the machine-learned models 110 and/or 140 using one or more training or learning algorithms. One example training technique is backwards propagation of errors (“backpropagation”). For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques (e.g., stochastic gradient descent) can be used to iteratively update the parameters over a number of training iterations.

In some implementations, the model trainer 160 can perform supervised training techniques using a set of labeled training data. In other implementations, the model trainer 160 can perform unsupervised training techniques using a set of unlabeled training data. In some implementations, partially labeled examples can be used with a multi-task learning approach to maximize data coverage and speed to delivery. The model trainer 160 can perform a number of generalization techniques to improve the generalization capability of the models being trained. Generalization techniques include weight decays, dropouts, or other techniques.

In particular, the model trainer 160 can train a machine-learned model 110 and/or 140 based on a set of training data 162. The model trainer 160 can be implemented in hardware, software, firmware, or combinations thereof.

FIG. 2 illustrates one example computing system 200 that can be used to implement the present disclosure. Other computing systems can be used as well. For example, in some implementations, the event intelligence computing system 102 can include the model trainer 160 and the training dataset 162. In such implementations, the machine-learned models 110 can be both trained and used locally at the event intelligence computing system 102. As another example, in some implementations, the event intelligence computing system 102 is not connected to other computing systems.

### Example Methods

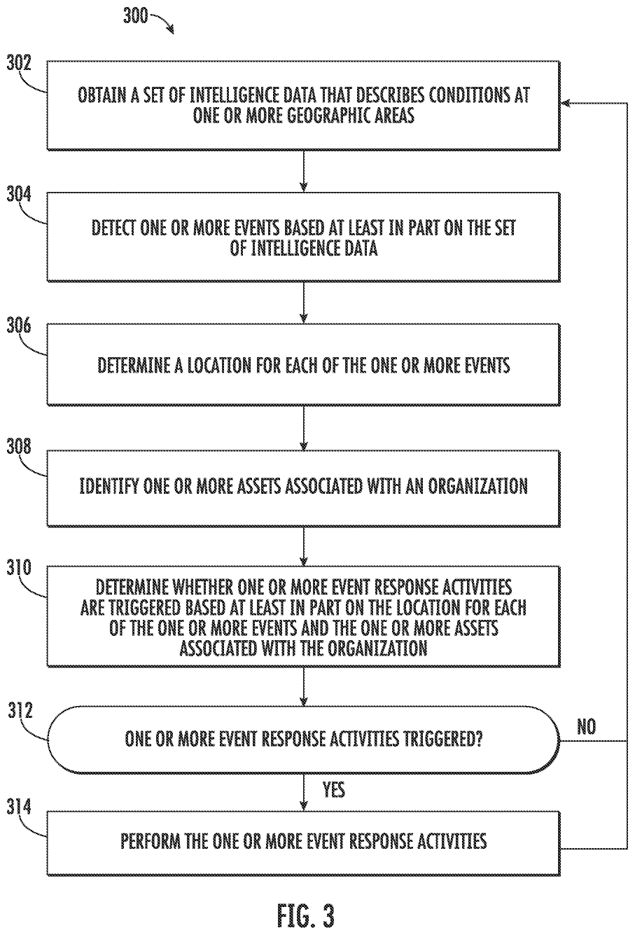

FIG. 3 depicts a flow chart diagram of an example method 300 to perform critical event detection and response according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, the method includes obtaining, by a computing system comprising one or more computing devices, a set of intelligence data that describes conditions at one or more geographic areas. As examples, the intelligence data can include structure data (e.g., a data feed from a governmental organization) and/or unstructured data (e.g., natural language data such as unstructured text, social media posts, news articles, satellite imagery, etc.).

At 304, the method includes detecting, by the computing system, one or more events based at least in part on the set of intelligence data. As one example, detecting the one or more events at 304 can include inputting, by the computing system, at least a portion of the set of intelligence data into a machine-learned event classification model and processing, by the computing system, at least the portion of the set of intelligence data with the machine-learned event classification model to produce one or more event inferences as an output of the machine-learned event classification model. Each of the one or more event inferences can detect one of the events and classify the event into an event type.

At 306, the method includes determining, by the computing system, a location for each of the one or more events. As one example, determining the location at 306 can include detecting, by the computing system, one or more location type entities within a portion of the set of intelligence data associated with the event and selecting, by the computing system, a first location type entity for the event based on the one or more location type entities, a gazetteer, and the portion of the set of intelligence data associated with the event.

As another example, determining the location at 306 can include inputting, by the computing system, at least a portion of the set of intelligence data associated with the event into the machine-learned event localization model and processing, by the computing system, at least the portion of the set of intelligence data with the machine-learned event localization model to produce an event location inference as an output of the machine-learned event localization model. The event location inference can identify the location for the event.

At 308, the method includes identifying, by the computing system, one or more assets associated with an organization. For example, identifying the one or more assets at 308 can include accessing a database that stores logical associations between assets and organizations.

In some implementations, identifying the one or more assets at 308 can include identifying, by the computing system, a respective asset location at which each of the one or more assets is located. In some implementations, the one or more assets can include one or more human personnel, and identifying, by the computing system, the respective asset location at which each of the one or more assets is located can include accessing, by the computing system, location data (e.g., GPS data) associated with one or more asset devices associated with the one or more human personnel.

In some implementations, the method 300 can also include determining, by the computing system, a severity level for each of the one or more events. In some implementations, the method 300 can include clustering, by the computing system, the one or more events based at least in part on the location or time for each of the one or more events to determine one or more event clusters.

At 310 and 312, the method includes determining, by the computing system, whether one or more event response activities are triggered based at least in part on the location for each of the one or more events and the one or more assets associated with the organization.

In some implementations, determining at 310 whether event response activities have been triggered includes determining, by the computing system, whether one or more alerts are triggered response activities are triggered based at least in on the location for each of the one or more events and the one or more assets associated with the organization.

In some implementations, determining at 310 whether event response activities have been triggered includes determining, by the computing system, whether a distance between the location for any of the one or more events and the respective asset location for any of the one or more assets is less than a threshold distance.

In some implementations, determining at 310 whether event response activities have been triggered includes evaluating, by the computing system, one or more user-defined trigger conditions.

If it is determined at 310 and 312 that no response actions have been triggered, then method 300 returns to 302 and obtains additional intelligence data. However, if it is determined at 310 and 312 that one or more response actions have been triggered, then method 300 proceeds to 314

At 314, the method includes, responsive to a determination at 312 that the one or more event response activities are triggered, performing, by the computing system, the one or more event response activities.

In some implementations, performing at 314 the one or more event response activities can include transmitting, by the computing system, one or more alerts to one or more asset devices associated with the one or more assets.

In some implementations, performing at 314 the one or more event response activities can include automatically modifying, by the computing system, one or more physical security settings (e.g., door lock settings, etc.) associated with the one or more assets (e.g., buildings).

In some implementations, performing at 314 the one or more event response activities can include automatically modifying, by the computing system, one or more logistical operations (e.g., flight or travel bookings/itineraries, supply chain operations, navigational routes, etc.) associated with the one or more assets (e.g., human personnel, products, shipments, etc.).

After 314, method 300 returns to 302 and obtains additional intelligence data. In such fashion, the computing system can perform critical event detection and response.

### Example Model Configurations

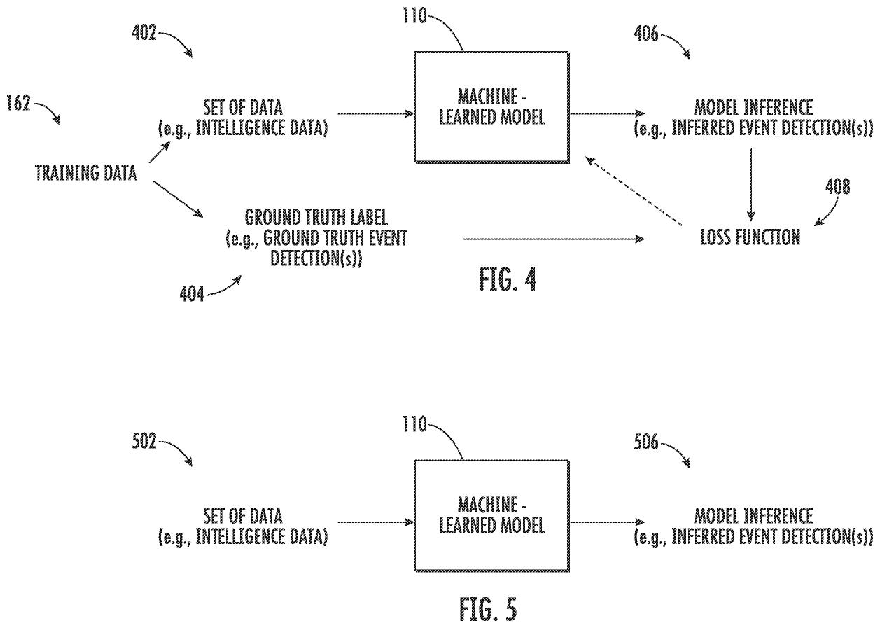

FIG. 4 depicts an example processing workflow for training a machine-learned model 110 according to example embodiments of the present disclosure. In particular, the illustrated training scheme trains the model 110 based on a set of training data 162.

The training data 162 can include, for example, past sets of intelligence or event data that have been annotated or labeled with ground truth information (e.g., the “correct” prediction or inference for the past sets of intelligence or event data). In some implementations, the training data 162 can include a plurality of training example pairs, where each training example pair provides: (402) a set of data (e.g., incorrect and/or incomplete data); and (404) a ground truth label associated with such set of data, where the ground truth label provides a “correct” prediction for the set of data.

As one example, the training example can include: (402) intelligence data; and (404) an indication of usefulness of the intelligence data. As another example, the training example can include: (402) intelligence data; and (404) one or more event types or classes for events described by the intelligence data. As another example, the training example can include: (402) intelligence data and/or event data such as event type data; and (404) a location and/or time at which one or more events described by the intelligence data and/or event data occurred or are occurring. As another example, the training example can include: (402) intelligence data and/or event data; and (404) a severity of one or more events described by the intelligence data and/or event data. As another example, the training example can include: (402) intelligence data and/or event data; and (404) one or more event response activities to be performed in response to one or more events described by the intelligence data and/or event data.

Based on the set of data 402, the machine-learned model 110 can produce a model prediction 406. As examples, the model prediction 406 can include a prediction of the ground truth label 404. Thus, as one example, if the ground truth label 404 provides one or more actual event types(s), then the model prediction 406 can correspond one or more predicted event type(s).

A loss function 408 can evaluate a difference between the model prediction 406 and the ground truth label 404. For example, a loss value provided by the loss function 408 can be positively correlated with the magnitude of the difference.

The model 110 can be trained based on the loss function 408. As an example, one example training technique is backwards propagation of errors (“backpropagation”). For example, the loss function 408 can be backpropagated through the model 110 to update one or more parameters of the model 110 (e.g., based on a gradient of the loss function 408). Various loss functions can be used such as mean squared error, likelihood loss, cross entropy loss, hinge loss, and/or various other loss functions. Gradient descent techniques can be used to iteratively update the parameters over a number of training iterations (e.g., until the loss function is approximately minimized).

FIG. 5 depicts an example processing workflow for employing the machine-learned model 110 following training according to example embodiments of the present disclosure.

As illustrated in FIG. 5, the machine-learned model 110 can be configured to receive and process a set of data 502. The set of data 502 can be of any of the different types of data discussed with respect to 402 of FIG. 4, or other forms of data. As one example, the set of data 502 can include intelligence data.

In response to the set of data 502, the machine-learned model 110 can produce a model prediction 506. The model prediction 506 can be of any of the different types of data discussed with respect to 404 or 406 of FIG. 4, or other forms of data. As one example, the model prediction 506 can include one or more detected events with event type and/or location.

### Example User Interfaces

FIGS. 6A-F depict example dashboard user interfaces according to example embodiments of the present disclosure. Referring first to FIG. 6A, FIG. 6A illustrates an example dashboard interface. The dashboard interface includes a map window with event markers placed on the map. Each event marker corresponds to a detected event. The map can also include asset markers that correspond to certain assets. The user can navigate (e.g., pan, zoom, etc.) in the map to explore different event and/or asset markers at different locations (e.g., zoom to the city of Chicago to see events occurring in Chicago). The user can select one of the event or asset markers to receive more detailed information about the corresponding event or asset.

In addition, in FIG. 6A, the dashboard is shown with a flights tab opened. The flight itineraries tab can show real-time and/or planned itinerary information for various flights associated with assets such as human personnel. More generally, a logistics tab can provide information about ongoing logistics (e.g., flights, shipments, or other ongoing transportation) of various assets.

FIG. 6B shows the dashboard interface with a people tab open. The people tab can show information for various human personnel such as current or most recent status. The people tab can provide a quick summary of all personnel (e.g., organized by location or other groupings). More generally, an asset tab can provide up to date information about various assets.

FIG. 6C shows the dashboard interface with an alerts tab opened. The alerts tab provides the user with the ability to obtain a summary overview of assets needing attention or help.

FIG. 6D shows the dashboard interface with a reports tab open. The reports tab can provide the user with an efficient interface to review news reports or other intelligence data, including information such as severity level, location on the map, etc.

FIG. 6E shows the dashboard interface with a notify tab open. The notify tab allows the user to control a mass notification system used to alert large groups of people potentially across the globe. The notify user interface allows the user to add individual recipients or to generate notifications based on geographical location by dragging a circle or other shape on the map around users or assets they want to notify.

FIG. 6F shows the dashboard interface with the filters tab open. The filters tab allows the user to filter events based on various filters, including filtering by severity, event type, time, etc.

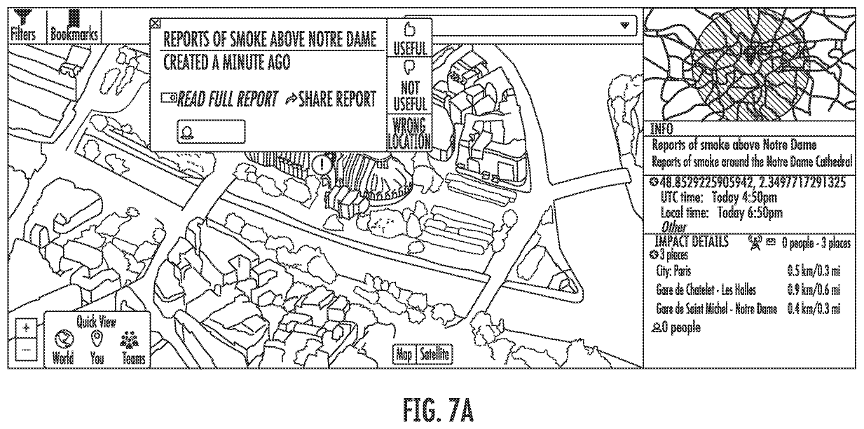

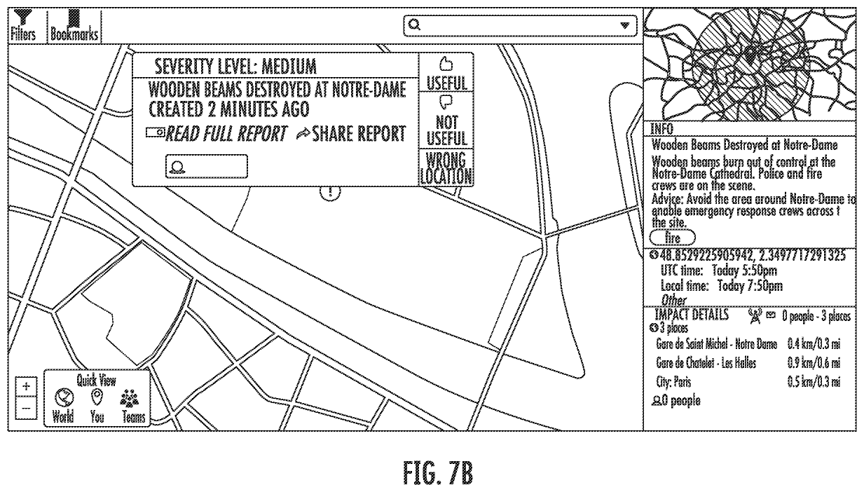

FIGS. 7A-B depict example event reports according to example embodiments of the present disclosure. In particular, FIGS. 7A-B depict a time lapse view of an example event which is a fire at the Notre Dame cathedral in Paris.

More particularly, referring to FIGS. 7A and 7B in conjunction with FIG. 1, a flow of the system operations and corresponding event reports can proceed as follows:

A satellite system can detect a high volume of smoke in central Paris. This satellite data and its associated geographical coordinates are pulled into the event intelligence system 102.

The incident is flagged as a potentially critical event (“fire”), but not yet definitively categorized as “arson” or “accidental.”

Initial press reports describe the wooden roof beams burning out of control. This data is pulled into the event intelligence system 102 and used to make an initial classification of the fire.

Social media feeds begin to stream thousands of posts and images of the blaze. The event intelligence system 102 pulls in social media reports from trusted sources and clusters these reports with the ongoing story.

Later press reports indicate that the fire was likely the cause of an electrical short circuit. This information is pulled into the event intelligence system 102 and used to categorize the incident as a “structure fire” (e.g., not “arson”).

In addition to the initial alert, issued within minutes of detection, organization computing systems 60 can receive an increasingly rich picture of the incident unfolding. Instead of a significant number of disparate reports on the fire, they see all relevant coverage clustered into a single event profile.

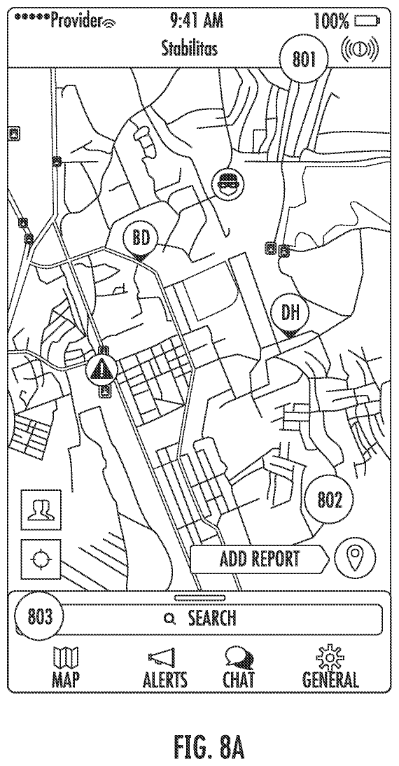

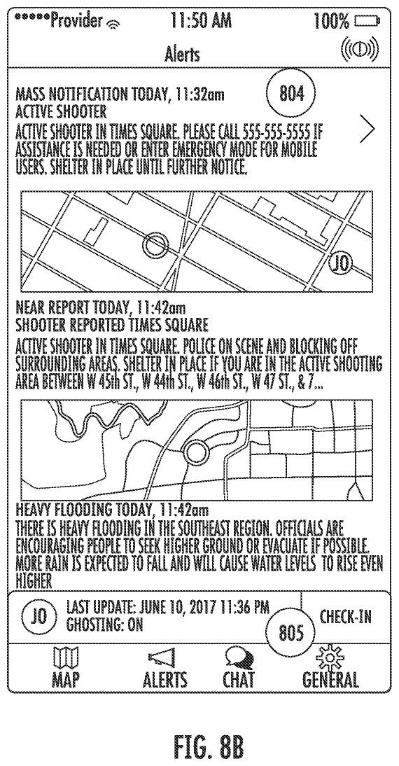

FIGS. 8A-B depict example mobile application user interfaces according to example embodiments of the present disclosure. In particular, in some implementations, a mobile application can work in tandem with the dashboard interface to connect an organization representative and an asset (e.g., employee).

Referring first to FIG. 8A, FIG. 8A shows the mobile user interface with a map tab open. In the map tab, the mobile user interface includes an emergency button (shown at 801). When pressed, the emergency button sends a message to the user's specified emergency contacts and/or an organization administrator. The map tab also includes an add report feature (shown at 802). The add report feature enables a user to report an event, including event information such as event type, event severity, event location, written or visual description, etc. The map tab can also include a search function (shown at 803) that allows the user to search the map for fellow teammates/coworkers, reports, or locations around the world.

FIG. 8B shows the mobile user interface with an alerts tab open. The alerts tab includes an alerts feed (shown at 804). The alerts feed includes alerts about events that will potentially impact the user. Each alert can be selected for additional information. The alerts tab also includes a status bar (shown at 805). The status bar shows the users' last check-in time, whether ghosting (e.g., hiding exact location within a 15 km radius) is on or off, and allows them to check-in with an organization administrator.

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for critical event intelligence, the method comprising:
obtaining, by a computing system comprising one or more computing devices, a set of intelligence data that describes conditions at one or more geographic areas;
detecting, by the computing system, one or more events based at least in part on the set of intelligence data;
determining, by the computing system, a location for each of the one or more events;
identifying, by the computing system, one or more assets associated with an organization;
determining, by the computing system, whether one or more event response activities are triggered based at least in part on the location for each of the one or more events and the one or more assets associated with the organization; and
responsive to a determination that the one or more event response activities are triggered, performing, by the computing system, the one or more event response activities.

2. The computer-implemented method of claim 1, wherein the set of intelligence data comprises structured data.

3. The computer-implemented method of claim 2, wherein the structured data comprises a data feed from a governmental organization.

4. The computer-implemented method of claim 1, wherein the set of intelligence data comprises unstructured data.

5. The computer-implemented method of claim 4, wherein the unstructured data comprises natural language data.

6. The computer-implemented method of claim 4, wherein the unstructured data comprises one or more social media posts or news articles.

7. The computer-implemented method of claim 4, wherein the unstructured data comprises one or more of: audio data, video data, or textual data generated from audio data or video data.

8. The computer-implemented method of claim 4, wherein the unstructured data comprises satellite imagery.

9. The-computer-implemented method of claim 1, wherein detecting, by the computing system, the one or more events based at least in part on the set of intelligence data comprises:
obtaining, by the computing system, a machine-learned event classification model;
inputting, by the computing system, at least a portion of the set of intelligence data into the machine-learned event classification model; and
processing, by the computing system, at least the portion of the set of intelligence data with the machine-learned event classification model to produce one or more event inferences as an output of the machine-learned event classification model, wherein each of the one or more event inferences detects one of the events and classifies the event into an event type.

10. The computer-implemented method of claim 1, wherein determining, by the computing system, the location for each of the one or more events within the one or more geographic areas comprises, for each of the one or more events:
detecting, by the computing system, one or more location type entities within a portion of the set of intelligence data associated with the event; and
selecting, by the computing system, a first location type entity for the event based on the one or more location type entities, a gazetteer, and the portion of the set of intelligence data associated with the event.

11. The-computer-implemented method of claim 1, wherein determining, by the computing system, the location for each of the one or more events within the one or more geographic areas comprises, for each of the one or more events:
obtaining, by the computing system, a machine-learned event localization model;
inputting, by the computing system, at least a portion of the set of intelligence data associated with the event into the machine-learned event localization model; and
processing, by the computing system, at least the portion of the set of intelligence data with the machine-learned event localization model to produce an event location inference as an output of the machine-learned event localization model, wherein the event location inference identifies the location for the event.

12. The computer-implemented method of claim 1, further comprising:
determining, by the computing system, a time for each of the one or more events;
wherein determining, by the computing system, whether the one or more event response activities are triggered comprises determining, by the computing system, whether the one or more event response activities are triggered based at least in part on the time determined for each of the one or more events.

13. The computer-implemented method of claim 1, further comprising:
determining, by the computing system, a severity level for each of the one or more events;
wherein determining, by the computing system, whether the one or more event response activities are triggered comprises determining, by the computing system, whether the one or more event response activities are triggered based at least in part on the severity level determined for each of the one or more events.

14. The computer-implemented method of claim 1, further comprising:
clustering, by the computing system, the one or more events based at least in part on the location or time for each of the one or more events to determine one or more event clusters;
wherein determining, by the computing system, whether the one or more event response activities are triggered comprises determining, by the computing system, whether the one or more event response activities are triggered based at least in part on the one or more event clusters.

15. The computer-implemented method of claim 1, wherein determining, by the computing system, whether one or more event response activities are triggered comprises determining, by the computing system, whether one or more alerts are triggered based at least in on the location for each of the one or more events and the one or more assets associated with the organization, and wherein performing, by the computing system, the one or more event response activities comprises transmitting, by the computing system, one or more alerts to one or more asset devices associated with the one or more assets.

16. The computer-implemented method of claim 1, wherein:
identifying, by the computing system, the one or more assets associated with the organization comprises identifying, by the computing system, a respective asset location at which each of the one or more assets is located; and
determining, by the computing system, whether one or more event response activities are triggered based at least in on the location for each of the one or more events and the one or more assets associated with the organization comprises determining, by the computing system, whether a distance between the location for any of the one or more events and the respective asset location for any of the one or more assets is less than a threshold distance.

17. The computer-implemented method of claim 16, wherein the one or more assets comprise one or more human personnel, and wherein identifying, by the computing system, the respective asset location at which each of the one or more assets is located comprises accessing, by the computing system, location data associated with one or more asset devices associated with the one or more human personnel.

18. The computer-implemented method of claim 1, wherein determining, by the computing system, whether one or more event response activities are triggered comprises evaluating, by the computing system, one or more user-defined trigger conditions.

19. The computer-implemented method of claim 1, wherein performing, by the computing system, the one or more event response activities comprises:
automatically modifying, by the computing system, one or more physical security settings associated with the one or more assets; or
automatically modifying, by the computing system, one or more logistical operations associated with the one or more assets.

20. A computing system, comprising:
one or more processors; and
one or more non-transitory computer-readable media that store instructions that, when executed by the one or more processors, cause the computing system to perform operations, the operations comprising:
obtaining, by the computing system, a set of intelligence data that describes conditions at one or more geographic areas;
detecting, by the computing system, one or more events based at least in part on the set of intelligence data;
determining, by the computing system, a location for each of the one or more events;
identifying, by the computing system, one or more assets associated with an organization;
determining, by the computing system, whether one or more event response activities are triggered based at least in part on the location for each of the one or more events and the one or more assets associated with the organization; and
responsive to a determination that the one or more event response activities are triggered, performing, by the computing system, the one or more event response activities.
